(19) United States
(12) Patent Application Publication
(10) Pub. No.: US 2008/0025279 A1
(43) Pub. Date: Jan. 31, 2008

(54) SYNCHRONIZATION OF MULTI-SYSTEM WAKEUP

(75) Inventors: Jason T. Young, Palm City, FL (US); Jaime A. Borras, Miramar, FL (US); Roberto Gautier, Davie, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/461,096

(22) Filed: Jul. 31, 2006

(51) Int. Cl. H04Q 7/28

(52) U.S. Cl. 370/341

(57) ABSTRACT

A method (200) for synchronizing wakeup of a second communication device (115) with wakeup of a first communication device (110). The method can include, on the first communication device, receiving a first message (135) from a communications network. The first message can indicate a first sleep/wake interval to be implemented on the first communication device. The method also can include communicating a second message (150) from the first communication device to the second communication device. The second message can indicate a second sleep/wake interval to be implemented on the second communication device. The second sleep/wake interval can be synchronized with the first sleep/wake interval. In one arrangement, the second sleep/wake interval can indicate to the second communication device to wakeup from sleep mode immediately after the first communication device has woken up from sleep mode.

### BACKGROUND OF THE INVENTION

1. Field of the Invention

The present invention generally relates to communication devices and, more particularly, to communication devices which implement sleep mode.

2. Background of the Invention

Modern communication devices, such as mobile stations, oftentimes include multiple transceivers. A first transceiver may be used to communicate with a communications network over a first communication link, while a second transceiver may be used to communicate with wireless accessories, such as a wireless headset, over a second communication link. The second communication link can be, for example, a communication link in accordance with the Bluetooth protocol or the ZigBee protocol.

The primary sources of energy for mobile stations and their wireless accessories are batteries. To accommodate demand for increased battery life, the mobile stations and wireless accessories typically enter a low power “sleep” mode while awaiting calls. In the sleep mode, battery drain is reduced, thereby preserving energy for call mode operation.

In order to detect incoming calls, a mobile station must periodically exit sleep mode to check for pages from the communications network over the first communication link. Similarly, a wireless accessory also must periodically exit sleep mode to “sniff” the second communication link to determine whether the mobile station requires use of the wireless accessory. To sniff the second communication link, the wireless accessory can detect a message, or beacon, from the mobile station that indicates the wireless accessory is needed. The wireless accessory can respond with a message indicating that the wireless accessory is available.

With presently available communication devices, the first communication link and the second communication link operate independently and their respective link maintenance duty cycles are asynchronous to one another. In order to assure that the wireless accessory is available to the mobile station when a call is detected, the duty cycle, or “sniff interval,” is typically much shorter than the duty cycle in which the mobile station checks for pages from the communications network. However, each sniff requires valuable energy to be expended both by the second communication device and the mobile station in order to generate, communicate and process the messages. In consequence, battery life on both of the devices is reduced.

### SUMMARY OF THE INVENTION

The present invention relates to a method for synchronizing wakeup of a second communication device with wakeup of a first communication device. The method can include, on the first communication device, receiving a first message from a communications network. The first message can indicate a first sleep/wake interval to be implemented on the first communication device. The method also can include communicating a second message from the first communication device to the second communication device. The second message can indicate a second sleep/wake interval to be implemented on the second communication device. The second sleep/wake interval can be synchronized with the first sleep/wake interval. In one arrangement, the second sleep/wake interval can indicate to the second communication device to wakeup from sleep mode immediately after the first communication device has woken up from sleep mode.

The method also can include, on the first communication device, entering sleep mode and waking up from sleep mode in accordance with the first sleep/wake interval. After waking up from sleep mode, a third message can be received from the communications network. The third message can indicate a third sleep/wake interval to be implemented on the first communication device. In addition, a fourth message can be communicated from the first communication device to the second communication device. The fourth message can indicate a fourth sleep/wake interval to be implemented on the second communication device. The fourth sleep/wake interval can be synchronized with the third sleep/wake interval. The method further can include, on the first communication device, receiving a sleep/wake interval confirmation from the second communication device. In addition, a network registration request can be communicated from the first communication device to the communications network.

The present invention also relates to a communication device. The communication device can include a first communications adapter that receives a first message from a communications network. The first message can indicate a first sleep/wake interval to be implemented on the communication device. The communication device also can include a second communications adapter that communicates a second message to the second communication device. The second message can indicate a second sleep/wake interval to be implemented on the second communication device. The second sleep/wake interval can be synchronized with the first sleep/wake interval. The second sleep/wake interval can indicate to the second communication device to wakeup from sleep mode immediately after the communication device has woken up from sleep mode.

The communication device also can include a controller which enters the communication device into sleep mode, and wakes up the communication device from sleep mode in accordance with the first sleep/wake interval. After waking up from sleep mode, the communications adapter can receive a third message from the communications network. The third message can indicate a third sleep/wake interval to be implemented on the communication device. In addition, the second communications adapter can communicate a fourth message to the second communication device. The fourth message can indicate a fourth sleep/wake interval to be implemented on the second communication device. The fourth sleep/wake interval can be synchronized with the third sleep/wake interval.

The second communications adapter also can receive a sleep/wake interval confirmation from the second communication device. Further, the communications adapter can communicate a network registration request to the communications network.

In another arrangement, a communication device can include a communications adapter that receives a first message from a second communication device. The first message can indicate a first sleep/wake interval to be implemented on the communication device. The first sleep/wake interval can be synchronized with a second sleep/wake interval implemented on the second communication device. The first sleep/wake interval can indicate to the communication device to wakeup from sleep mode immediately after the second communication device has woken up from sleep mode. Further, the communications adapter can communicate a sleep/wake interval confirmation to the second communication device.

### BRIEF DESCRIPTION OF THE DRAWINGS

Preferred embodiments of the present invention will be described below in more detail, with reference to the accompanying drawings, in which:

FIG. 1 depicts a communications system that is useful for understanding synchronization of multi-system wakeup in accordance with the present invention;

FIG. 2 depicts a signal flow diagram that is useful for understanding synchronization of multi-system wakeup in accordance with the present invention;

FIG. 3 depicts the communications system of FIG. 1 in an arrangement which is useful for understanding call processing in accordance with the present invention;

FIG. 4 depicts another signal flow diagram that is useful for understanding call processing in accordance with the present invention;

FIG. 5 depicts a block diagram of a first communication device that is useful for understanding the present invention; and

FIG. 6 depicts a block diagram of a second communication device that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for synchronizing wakeup of a first communication device with wakeup of a second communication device that communicates with the first communication device. Having the wakeup of the respective devices synchronized allows for a much longer duty cycle, or “sniff interval,” to be used by the second communication device. Moreover, implementation of the synchronized wakeup also will result in fewer messages being generated by the first and second communication devices to establish a communication link, thereby reducing energy usage and extending battery life on both of the devices.

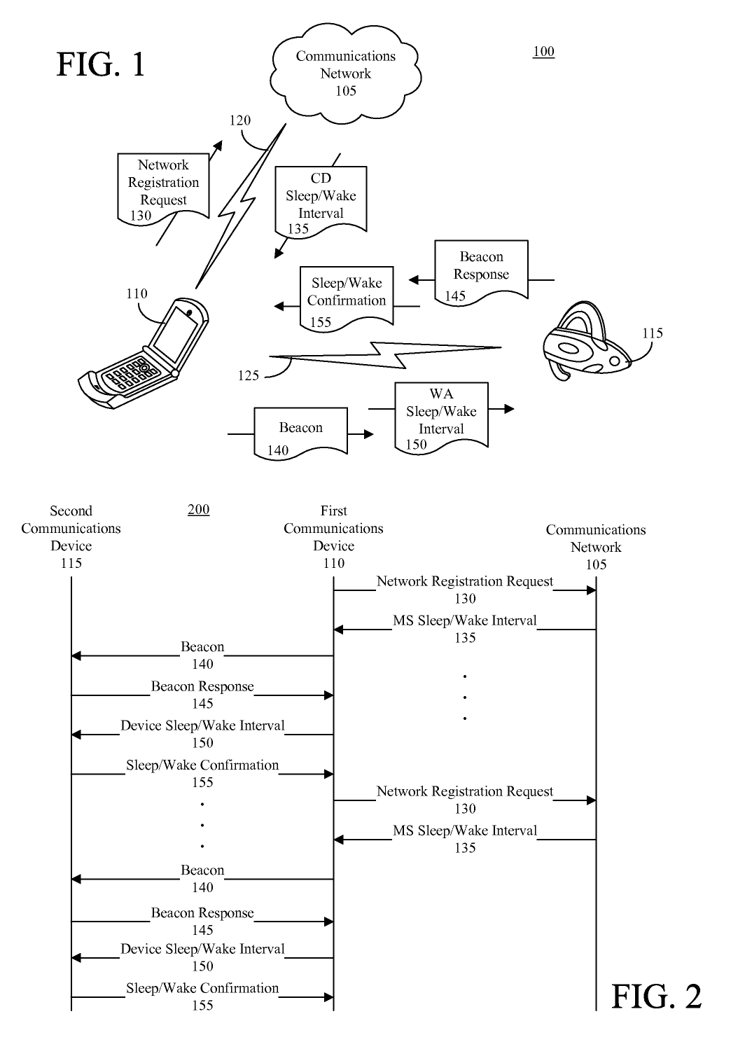

FIG. 1 depicts a communications system 100 that is useful for understanding synchronization of multi-system wakeup in accordance with the present invention. The communications system 100 can include a communications network 105, which can comprise, for example, the Internet, the World Wide Web, a wide area network (WAN), a local area network (LAN), a cellular communications network, a dispatch communications network, a public switched telephone network (PSTN), and/or any other networks or systems over which communication signals can be propagated. In that regard, the communications network can include wired and/or wireless communication links.

The communications system 100 also can include a first communication device 110 communicatively linked to the communications network 105 via a first communication link 120. The first communication device 110 can be a mobile station, such as a mobile computer, a personal digital assistant (PDA) or a mobile telephone, a game console, or any other electronic apparatus that may be used to wirelessly communicate with the communications network 105. A second communication device 115 can be communicatively linked to the first communication device 110 via a second communication link 125. The second communication device 115 can be a wireless accessory, for example as a wireless headset, or any other device that may be wirelessly linked to the first communication device 110.

FIG. 2 depicts a signal flow diagram that is useful for understanding a method 200 for implementing synchronization of multi-system wakeup in accordance with the present invention. Referring both to FIG. 1 and FIG. 2, the process can begin with the first communication device 110 forwarding a network registration request 130 to the communications network 105. The network registration request 130 can be processed, for example, by a base transceiver station (BTS), a base station controller (BSC), a mobile switching center (MSC), a network server, or any other suitable network devices.

In response to the network registration request, the communications network 105 can forward a message 135 to the first communication device 110 that indicates the sleep/wake interval to be used by the first communication device 110. As used herein, the term “sleep/wake interval” is the interval at which a device or accessory wakes up from sleep mode and/or enters sleep mode. For instance, the message 135 can indicate to the first communication device 110 when to exit sleep mode to check for pages from the communications network 105 over the first communication link 120. The interval can be, for example 1 sec., 2 sec., 3 sec., 5 sec. or any other desired interval. The message 135 also can indicate to the first communication device 110 how long to stay awake before again entering sleep mode.

In one arrangement, the first communication device 110 also can periodically communicate a beacon 140, or message, to the second communication device 115 that indicates the second communication device 115 is required. If the second communication device 115 has not yet synchronized its sniff interval with the sleep/wake interval of the first communication device 110, the second communication device 115 can sniff for the beacon 140 at a default rate. Once synchronized, however, the second communication device 115 can sniff for the beacon 140 at the same interval at which the first communication device 110 wakes up from sleep mode, as will be described.

After receiving the beacon 140, the second communication device 115 can provide a beacon response 145 to the first communication device 110 to indicate that the beacon 140 has been received and that the communication link 125 is established. In another arrangement, the second communication device 115 can provide the beacon 140 to the first communication device 110, and the first communication device 110 can provide the beacon response 145 to the second communication device 115.

If the first communication device 110 is not being paged by the communications network 105 (i.e. no calls are being received for the first communication device 110), after receiving the beacon response 145, the first communication device 110 can send a message 150 to the second communication device 115. The message 150 can indicate the sleep/wake interval to be used by the second communication device 115. For instance, the message 150 can indicate when the second communication device 115 should wakeup from sleep mode and sniff for the beacon 140, and how long the second communication device 115 should stay awake before again entering sleep mode.

Notably, the sleep/wake interval conveyed in the message 150 can be synchronized with the sleep/wake interval used by the first communication device 110. For instance, the message 150 can indicate to the second communication device 115 to exit sleep mode and sniff for a beacon 140 immediately after the next time that the first communication device 110 exits sleep mode. After receiving the message 150, the second communication device 115 can communicate a message 155 to the first communication device 110 confirming the sleep/wake interval.

If the first communication device 110 is not receiving a page from the communications network 105, both the first communication device 110 and the second communication device 115 can enter sleep mode after the first communication device 110 has communicated the synchronous sleep/wake interval to the second communication device 115. After the interval communicated in the message 135, the first communication device 110 can exit sleep mode and send another message 130 that includes the network registration request. The communications network 105 can again respond with a message 135 containing a new sleep/wake interval. The new sleep/wake interval can be the same as the sleep/wake interval previously communicated to the first communication device 110, or can be a different interval selected for changing requirements of the communications network 105. Further, the first communication device 110 can again communicate a beacon 140 to the second communication device 115.

The second communication device 115 can exit sleep mode in accordance with the sleep/wake interval communicated in the message 150, and again sniff for the beacon 140 and provide the beacon response 145. The first communication device 110 then can forward to the second communication device 115 the message 150 containing a sleep/wake interval synchronized to the latest sleep/wake interval received by the first communication device 110. The process of exchanging the messages 130-150 can continue until the first communication device 110 receives a page from the communications network 105.

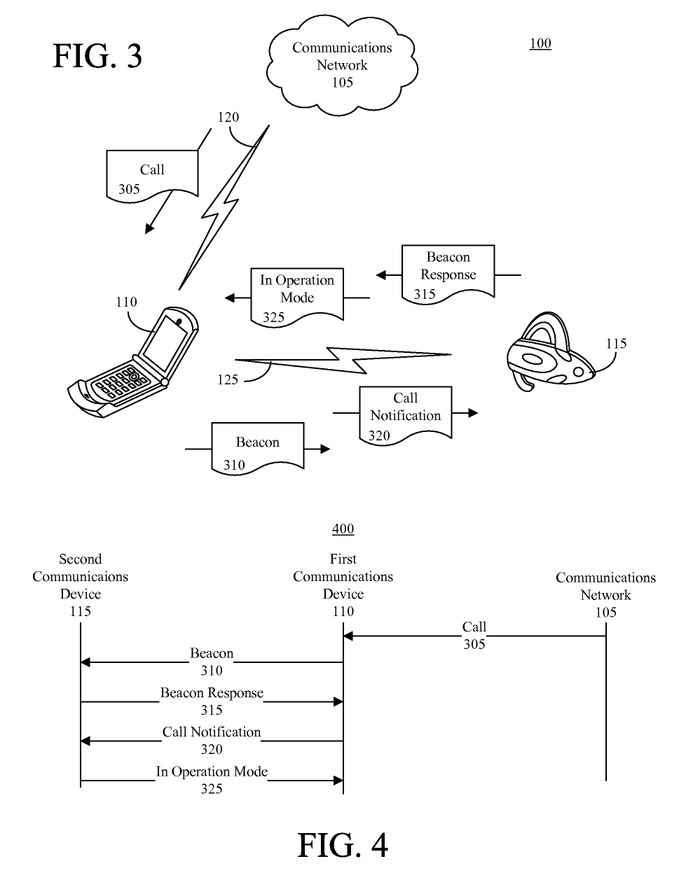

FIG. 3 depicts the communications system of FIG. 1 in an arrangement which is useful for understanding call processing in accordance with the present invention. FIG. 4 depicts another signal flow diagram that is useful for understanding a method 400 for implementing call processing in accordance with the present invention. Referring both to FIG. 3 and FIG. 4, if after exiting sleep mode the first communication device 110 receives a call 305, or page, from the communications network 105, the first communication device 110 can again communicate a beacon 310 to the second communication device 115, which again can provide a beacon response 315 back to the first communication device 110 to indicate that the beacon 310 was received and that the communication link 125 is established. The first communication device 110 then can provide a call notification 320 that indicates to the second communication device 115 to enter operation mode. For example, in an arrangement in which the second communication device 115 is a wireless headset, the call notification 320 can indicate to the communication device 115 to maintain the communication link 125 for exchange of audio information. The second communication device 115 can respond with a message 325 that indicates the second communication device has entered the operation mode.

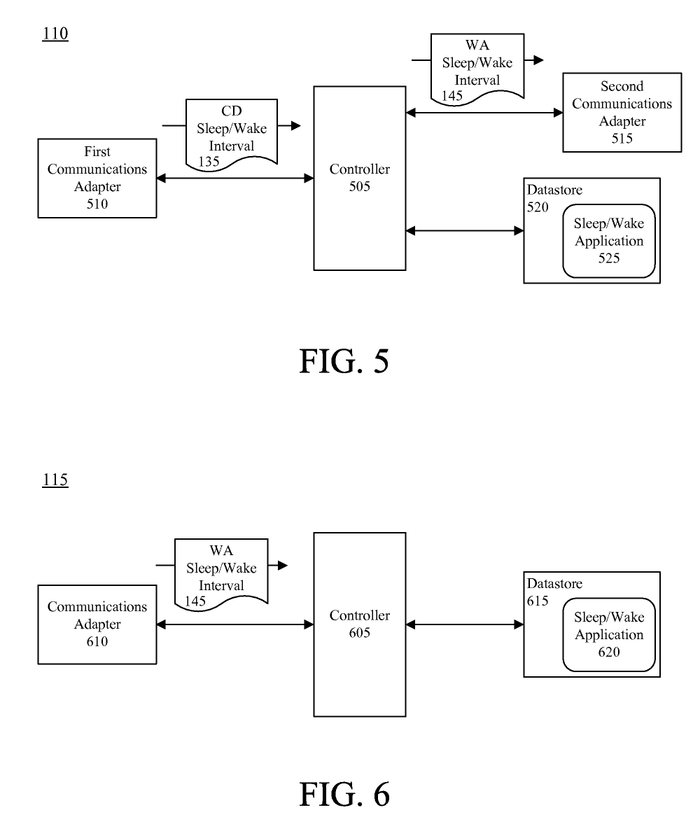

FIG. 5 depicts a block diagram of a first communication device 110 that is useful for understanding the present invention. The first communication device 110 can include a controller 505. The controller 505 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The first communication device 110 also can include a first communications adapter 510 that is used by the first communication device 110 to communicate with the communications network and to receive the message 135 containing the sleep/wake interval information. The first communications adapter 510 can include, for example, a transceiver that communicates data via IEEE 802 wireless communications, WPA, WPA2, GSM, TDMA, CDMA, WCDMA, direct wireless communication, TCP/IP, or any other suitable form of mobile communications.

The first communication device 110 also can include a second communications adapter 515 that is used by the first communication device 110 to communicate with the second communication device and provide the message 150 containing the sleep/wake interval information for the second communication device. For example, the second communications adapter 515 can include a transceiver or receiver configured to communicate in accordance with the Bluetooth protocol or the ZigBee protocol.

The first communication device 110 also can include a datastore 520. The datastore 520 can include a magnetic storage medium, an electronic storage medium, an optical storage medium, a magneto-optical storage medium, or any other storage medium suitable for storing digital information. In one arrangement, the datastore 520 can be integrated into the controller 505.

A sleep/wake application 525 can be contained on the datastore 520. The sleep/wake application 525 can be executed by the controller 505 to implement the methods and processes described herein. For example, the sleep/wake application 525 can process the various messages transmitted and received by the first communication device 110, determine the sleep/wake interval for the second communication device, enter the first communication device 110 into sleep mode, wakeup the first communication device 110, and so on.

FIG. 6 depicts a block diagram of a second communication device 115 that is useful for understanding the present invention. The second communication device 115 can include a controller 605. The controller 605 can comprise, for example, a CPU, a DSP, an ASIC, a PLD, a plurality of discrete components that cooperate to process data, and/or any other suitable processing device.

The second communication device 115 also can include a communications adapter 610 that is used by the second communication device 115 to communicate with the first communication device and receive the message 150 containing the sleep/wake interval information for the second communication device 115. For example, the communications adapter 610 can include a transceiver or receiver configured to communicate in accordance with the Bluetooth protocol or the ZigBee protocol.

The second communication device 115 also can include a datastore 615. The datastore 615 can include a magnetic storage medium, an electronic storage medium, an optical storage medium, a magneto-optical storage medium, or any other storage medium suitable for storing digital information. In one arrangement, the datastore 615 can be integrated into the controller 605.

A sleep/wake application 620 can be contained on the datastore 615. The sleep/wake application 620 can be executed by the controller 605 to implement the methods and processes described herein. For example, the sleep/wake application 620 can process the various messages transmitted and received by the second communication device 115, enter the second communication device 115 into sleep mode, wakeup the second communication device 115, and so on.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for synchronizing wakeup of a second communication device with wakeup of a first communication device, comprising:
on the first communication device, receiving a first message from a communications network, the first message indicating a first sleep/wake interval to be implemented on the first communication device; and
from the first communication device, communicating a second message to the second communication device, the second message indicating a second sleep/wake interval to be implemented on the second communication device.

2. The method of claim 1, wherein the second sleep/wake interval is synchronized with the first sleep/wake interval.

3. The method of claim 2, wherein the second sleep/wake interval indicates to the second communication device to wakeup from sleep mode immediately after the first communication device has woken up from sleep mode.

4. The method of claim 1, further comprising:
on the first communication device, receiving a sleep/wake interval confirmation from the second communication device.

5. The method of claim 1, further comprising:
communicating a network registration request from the first communication device to the communications network.

6. The method of claim 1, further comprising:
on the first communication device, entering sleep mode; and
waking up from sleep mode in accordance with the first sleep/wake interval.

7. The method of claim 6, further comprising:
after waking up from sleep mode, receiving a third message from the communications network, the third message indicating a third sleep/wake interval to be implemented on the first communication device; and
from the first communication device, communicating a fourth message to the second communication device, the fourth message indicating a fourth sleep/wake interval to be implemented on the second communication device.

8. The method of claim 7, wherein the fourth sleep/wake interval is synchronized with the third sleep/wake interval.

9. A communication device, comprising:
a first communications adapter that receives a first message from a communications network, the first message indicating a first sleep/wake interval to be implemented on the communication device; and
a second communications adapter that communicates a second message to a second communication device, the second message indicating a second sleep/wake interval to be implemented on the second communication device.

10. The communication device of claim 9, wherein the second sleep/wake interval is synchronized with the first sleep/wake interval.

11. The communication device of claim 10, wherein the second sleep/wake interval indicates to the second communication device to wakeup from sleep mode immediately after the communication device has woken up from sleep mode.

12. The communication device of claim 9, wherein the second communications adapter further receives a sleep/wake interval confirmation from the second communication device.

13. The communication device of claim 9 wherein the first communications adapter further communicates a network registration request to the communications network.

14. The communication device of claim 9, further comprising a controller which enters the communication device into sleep mode, and wakes up the communication device from sleep mode in accordance with the first sleep/wake interval.

15. The communication device of claim 14, wherein:
after waking up from sleep mode, the first communications adapter receives a third message from the communications network, the third message indicating a third sleep/wake interval to be implemented on the communication device; and
the second communications adapter communicates a fourth message to the second communication device, the fourth message indicating a fourth sleep/wake interval to be implemented on the second communication device.

16. The communication device of claim 15, wherein the fourth sleep/wake interval is synchronized with the third sleep/wake interval.

17. A communication device comprising a communications adapter that receives a first message from a second communication device indicating a first sleep/wake interval to be implemented on the communications device.

18. The communication device of claim 17, wherein the first sleep/wake interval is synchronized with a second sleep/wake interval implemented on the second communication device.

19. The communication device of claim 18, wherein the first sleep/wake interval indicates to the communication device to wakeup from sleep mode immediately after the second communication device has woken up from sleep mode.

20. The communication device of claim 17, wherein the communications adapter further communicates a sleep/wake interval confirmation to the communication device.
